(19) United States
(12) Patent Application Publication
(10) Pub. No.: US 2006/0000207 A1
(43) Pub. Date: Jan. 5, 2006

(54) Regenerative drive system for trailers

(76) Inventor: Allan Rush, New South Wales (AU)

Correspondence Address: Christine A Lekutis;Medlen & Carroll, Suite 350, 101 Howard Street, San Francisco, CA, 94105, US

(21) Appl. No.: 10/528,252

(22) PCT Filed: Sep. 19, 2003
(86) PCT No.: PCT/AU03/01236

§ 371 Date: Mar. 17, 2005

(30) Foreign Application Priority Data
Sep. 20, 2002 (AU) 2002951538

(51) Int. Cl. F16D 31/02

(52) U.S. Cl. 60/413

(57) ABSTRACT

A regenerative energy management system (1) adapted for use with a compound vehicle including a prime mover, drive train and a trailer (2) including independent wheels (3) isolated from the prime mover drive train. The system (1) includes energy accumulation means (5) operable selectively to store and release energy through controlled receipt and release of pressurised hydraulic fluid; a positive displacement hydraulic pump/motor assembly (8) in fluid communication with the energy accumulation means (5); and a low-pressure hydraulic reservoir (9) in fluid communication with pump/motor assembly. The pump/motor assembly (8) has a drive shaft for connection to at least one of the wheels (3). In a braking mode, the assembly (8) retards the associated wheel (3) by pumping hydraulic fluid into the accumulation means (5) while in a driving mode, it supplies supplementary power using hydraulic fluid from the accumulation means (5) and in a neutral mode, it exerts no substantial driving or retarding influence on the wheel (3).

### FIELD OF INVENTION

The present invention relates generally to land haulage vehicles, and in particular to haulage vehicles having at least one wagon or trailer connected to a prime mover.

The invention has been developed primarily for use with road transport vehicles and will be described predominantly hereinafter in the context of semi-trailers of the type typically drawn behind prime movers. It should be appreciated, however, that the invention is not limited to this particular field of use, being readily adaptable to any type of wagon or trailer, whether pushed or pulled, in virtually any application. Other applications include rail carriages, bogies and wagons, articulated lorries, articulated buses, road trains comprising multiple trailers, caravans and boat trailers. It should also be appreciated that the invention is applicable to off-road applications.

### BACKGROUND OF THE INVENTION

The following discussion of the prior art is intended solely to place the invention in an appropriate context, and allow a proper appreciation of its technical significance. However, statements made in this specification about prior art information should not be construed as admissions that such information is widely known, or forms part of common general knowledge in the relevant field.

Heavy land transport vehicles often include one or more non-powered trailers or “dogs” for attachment to a prime mover or truck. While these trailers do not usually include a motivating engine themselves, they often are provided with ancillary systems such as lighting and cooling. In addition, it is common for such trailers to include supplementary braking systems to enhance the overall braking performance of the vehicle. The contribution of the supplementary braking system becomes proportionally more important, in comparison to the braking system of the prime mover, when the trailer is laden. This is because proportionally more weight is applied to the wheels of the trailer when laden and also because in many cases, the combined contact area between the trailer wheels and the road is greater than the corresponding contact area associated with the prime mover. For both reasons, the trailer wheels are also often able to generate greater frictional force with respect to the road surface. It follows that a correspondingly greater amount of braking energy will be lost when the laden trailer is retarded, with most of this energy being dissipated as heat. The cost of this unrecoverable loss of energy manifests in a number of ways including fuel and oil costs, as well as rapid wear in brake, clutch and transmission components. These costs are highest in situations where the vehicle must frequently accelerate and decelerate, for example in traffic, on delivery runs dictating frequent stops, and in undulating terrain.

There is also an inherent safety risk in set-ups of this type. This is because if the braking system on the trailer or wagon fades or fails, the braking system on the prime mover is often inadequate to retard the combined mass of the vehicle quickly and effectively, particularly if the trailer is fully laden. Situations of this type are known to have caused a variety of trucking accidents including collisions with other vehicles, jack-knifing, overturning, and failure to negotiate corners, all with potentially fatal consequences. The safety risk is further compounded in situations where the trailer or wagon carries toxic or flammable loads, as well as other hazardous materials such as compressed gas.

Regenerative drive and braking systems have been developed in an attempt to store and reuse a proportion of the braking energy that is usually wasted in land transportation and similar applications. For example, a particularly effective regenerative drive system (“RDS”) is described by the present applicant in an earlier patent application filed via the Patent Cooperation Treaty (PCT) as international application No PCT/AU99/00740, the full contents of which are hereby incorporated by reference. The RDS described in that earlier patent application is based upon a positive displacement pump/motor arrangement incorporating a cylinder block which houses a cylindrical array of axially reciprocating pistons. In one preferred embodiment, the cylinder block and valve face are coaxially disposed around the primary drive shaft, thereby avoiding the need for intermediate gearing, chains, belts or other transmission elements.

When used in conjunction with an accumulator and a suitable control mechanism, the resultant regenerative drive system provides a practical and commercially viable system for harnessing the previously wasted braking energy, storing this energy, and subsequently releasing it into the drive train as required under conditions of acceleration, heavy load, or gear change transitions. In this way, the RDS arrangement significantly improves the overall efficiency of the engine and power transmission systems of the prime mover while also conveniently acting as an efficient auxiliary braking mechanism for the prime mover in the energy accumulation mode. Unfortunately, however, in conventional semi-trailers, rail wagons and analogous set-ups in many other transport vehicles, the drive train of the prime mover is isolated from the trailer, and consequently, much of the braking energy has hitherto been unrecoverable and many of the inherent safety risks remain.

It is an object of the present invention to overcome or substantially ameliorate one or more of these deficiencies of the prior art, or at least to provide a useful alternative.

### DISCLOSURE OF THE INVENTION

Accordingly, in a first aspect, the invention provides a regenerative energy management system adapted for use with a compound vehicle comprising a prime mover including an engine connected to driven wheels via a drive train and a trailer including at least one independent wheel isolated from the drive train, the energy management system including:

energy accumulation means operable selectively to store and release energy through controlled receipt and release of pressurised hydraulic fluid;

a positive displacement hydraulic pump/motor assembly in fluid communication with the energy accumulation means; and

a low-pressure hydraulic reservoir in fluid communication with the pump/motor assembly;

the pump/motor assembly having a drive shaft adapted for connection to at least an associated one of the independent wheels of the trailer;

the system being arranged such that in a braking mode the pump/motor assembly retards the associated wheel of the trailer by pumping hydraulic fluid into the accumulation means, in a driving mode the pump/motor assembly supplies supplementary power to the associated wheel of the trailer using pressurised hydraulic fluid from the accumulation means, and in a neutral mode the pump/motor assembly exerts no substantial driving or retarding influence on the associated trailer wheel;

the system thereby in use being adapted to supply regenerative drive and retardation to the trailer substantially independently of the prime mover.

It will be appreciated that the same pump/motor assembly may be used in one mode as a motor, and in another mode as a pump. It should therefore be understood that throughout the specification, these terms may be used in conjunction, or interchangeably. In each case, however, unless the context clearly dictates otherwise, any reference to configuration of the unit as a pump should be understood to include configurations as a motor, and vice versa. It should also be understood that the inlet and outlet ports may alternate in function according to the mode of operation of the unit.

Further, it should be understood that the term “prime mover” is intended to be interpreted in the widest sense of a primary source of motive power or drive, including but not limited to a prime mover of the type commonly associated with semi trailers.

It should also be understood that the term “trailer” is intended to include any non-powered vehicle configured to be drawn behind or pushed in front of a primary source of motive power, or prime mover, including but not limited to semi-trailers, transport vehicles, caravans, rail wagons, freight cars and carriages as well as other articulated vehicles and special-purpose trailers. It is also intended to include arrangements where the system is applied to wheels connected directly to a prime mover but supported for rotation independently of the primary drive train.

Preferably, the positive displacement hydraulic pump/motor assembly includes:

a rotary cylinder block having a central axis and incorporating a generally circular array of cylinders disposed in parallel relationship around the axis;

a corresponding plurality of axial pistons reciprocably disposed within the respective cylinders;

a drive plate disposed at one end of the cylinder block to effect sequentially staggered reciprocation of the pistons in response to rotation of the cylinder block;

a stationary valve plate disposed at an opposite end of the cylinder block, the valve plate having a valve face adapted for sliding rotational engagement with a complementary mating face formed on the cylinder block;

the valve plate further including at least one inlet port adapted for fluid communication with the low-pressure reservoir and at least one outlet port adapted for fluid communication with an hydraulic load;

the ports being disposed such that in use, hydraulic fluid is progressively drawn into the cylinders in sequence as the respective pistons are displaced away from the valve plate and subsequently expelled from the cylinders as the pistons are progressively displaced toward the valve plate.

Preferably, the drive shaft extends coaxially through a complementary bore formed in the cylinder block, to effect rotation of the cylinder block about the central axis. The pump/motor assembly preferably further includes a selectively releasable decoupling mechanism disposed effectively intermediate the drive shaft and the cylinder block. The decoupling mechanism is preferably adapted in an engaged mode to connect the drive shaft to the cylinder block and in a disengaged mode to allow the drive shaft to rotate substantially independently of the cylinder block. In the preferred embodiment, the decoupling means include a clutch mechanism, desirably in the form of a multi-plate clutch disposed coaxially around the drive shaft. The clutch desirably acts between the drive shaft and the cylinder block, so as to selectively transmit rotary drive. It should be appreciated, however, that in alternative embodiments, the drive shaft may be permanently connected to the cylinder block. It should also be appreciated that gears, clutches, or other coupling mechanisms may be interposed to transmit rotary drive between the associated wheel of the vehicle and the drive shaft and/or between the drive shaft and the cylinder block of the pump/motor unit. Such transmissions may be mechanical, hydraulic, pneumatic or electromagnetic. They may also be permanently engaged or decouplable, manual or automatic, and may include constant or variable reduction ratios.

In a particularly preferred embodiment, the positive displacement pump/motor is a swash plate type unit. In this embodiment, the drive plate takes the form of a stationary swash plate, which is inclined with respect to the central rotational axis of the cylinder block. Preferably also, the ends of the pistons remote from the valve plate include “followers” adapted to slide over the swash plate as the cylinder block rotates. A hold-down plate is preferably disposed to capture the floating ends of the pistons and retain the followers in sliding contact with the swash plate. In alternative embodiment, however, springs or other suitable means may be used to retain the followers in contact with the swash plate.

Preferably, the angle of inclination of the swash plate is selectively adjustable, to provide variable flow rate characteristics. In particular, the swash plate is preferably adapted to be selectively inclined in a positive or a negative sense, thereby enabling the assembly alternately to operate as a motor or a pump. Most preferably, the variable swash plate can also be oriented in an intermediate or neutral position, effectively normal to the central axis, such that rotation of the cylinder block causes no movement of the pistons, hence induces no net flow into or out of the cylinders through the ports, and therefore causes no load on the system aside from a residual level of inherent frictional drag.

In other embodiments, it will be appreciated that the invention may also be applied to a bent axis type hydraulic pump. In that case, connecting rods for the pistons are pivotably attached to a thrust plate adapted to rotate with the cylinder block. The invention may also be adaptable to other configurations of motors and pumps.

Preferably, the pump/motor assembly includes at least three external ports to permit ingress and egress of hydraulic fluid, with a first port communicating with an inlet of the hydraulic reservoir, a second port communicating with an outlet of the hydraulic reservoir, and a third port communicating with the accumulator. A heat exchanger is preferably disposed between the first port and the hydraulic fluid reservoir.

In one embodiment of the invention, a plurality of positive displacement axial piston pumps is arranged axially along the drive shaft. These pumps may be connected hydraulically to operate in series, parallel, or a combination of both.

Preferably, the energy management system includes a flow control circuit through which hydraulic fluid may be selectively directed, the control circuit being adapted to provide a controllable resistance enabling the pump/motor unit selectively to exert a retarding force on the drive shaft when required, even if the accumulators are fully charged.

Preferably, the accumulation means include a gas/liquid accumulator comprising a double-ended cylinder and a piston adapted to float sealingly within the cylinder. One side of the cylinder preferably contains a compressible inert gas such as nitrogen, while the other side of the cylinder is preferably connected hydraulically to the pump/motor unit. The accumulator is preferably thereby adapted to store energy by pumping hydraulic fluid into one side of the cylinder, so as to compress the gas on the other side by displacement of the floating piston, and subsequently to release that energy by expulsion of hydraulic fluid as the compressed gas expands. In alternative embodiments, however, other forms of accumulator, such as bladder, bellows or diaphragm type accumulators, may be readily substituted.

The assembly preferably includes a plurality of accumulators, which may be selectively connected in series, parallel or a combination of both, as required.

In one preferred configuration, the pump/motor unit is mounted directly to a “freewheeling” axle supporting one or more associated non-driven wheels of the trailer, such that the axle integrally forms the drive shaft of the pump/motor unit.

In a particularly preferred configuration, the pump/motor unit is connected to a corresponding pair of associated non-driven wheels disposed on opposite sides of the trailer via a differential. In this case, the main pinion shaft for the differential preferably forms the drive shaft of the pump/motor unit. In a more sophisticated a variation of this configuration, two or more pairs of trailer wheels may be connected to the same pump/motor unit via respective differentials and a common pinion shaft. In this way, four or more associated trailer wheels may be regulated by a single pump/motor unit, and optionally configured as a discretely detachable bogie assembly. If desired, the differentials may have limited slip or locking capability, thereby permitting torque bias in the event of one wheel losing traction. Additional pump/motor units may optionally be disposed along the common pinion shaft, or connected to other non-driven wheels.

Preferably, the axle configuration described is retarded by a control system in proportion to the retardation of the prime mover. It will be appreciated, however, that if the retardation force available from the system is sufficient, it may be used to provide the sole retardation force for the combined vehicle mass, independently of the prime mover. Similarly, within the limits of the system, controlled propulsion of the total vehicle mass may be achieved from the trailer, independently of the prime mover and the main drive train. It should also be appreciated that the independent trailer mounted system described may be used in conjunction with an RDS connected directly to the drive line of the prime mover.

### BRIEF DESCRIPTION OF THE DRAWINGS

A preferred embodiment of the invention will now be described, by way of example only, with reference to the accompanying drawings in which:

FIG. 1 is a cut-away perspective view showing an RDS incorporated into a trailer of the type adapted to be drawn by a prime mover, according to the invention;

FIG. 2 is an enlarged perspective view showing in more detail the four sets of wheels from the trailer of FIG. 1, drivingly connected via the associated axles and differentials to the pump/motor unit;

FIG. 3 is an underside perspective view of the arrangement shown in FIG. 2;

FIG. 4 is an enlarged cross-sectional view showing the pump/motor unit from the RDS of FIGS. 1 to 3;

FIG. 5 is an enlarged cross-sectional view showing the hydraulic accumulator from the RDS shown in FIGS. 1 to 4; and

FIGS. 6A to 6D show a sequence of schematics illustrating the hydraulic circuit connecting the pump/motor unit, low-pressure reservoir, high-pressure accumulators, and associated system controllers for the RDS in the various operational modes, according to the invention.

### PREFERRED EMBODIMENT OF THE INVENTION

Referring to the drawings, the invention provides a regenerative drive and energy management system (RDS) 1, adapted for use with a compound vehicle including a primary source of motive power, or prime mover (not shown). The prime mover would typically include an engine connected to driven wheels via a transmission and primary drive train (also not shown), and coupling means adapted for connection to a trailer 2. The trailer 2 includes wheels 3 isolated from the primary drive train.

In broad overview, the RDS includes energy accumulation means in the form of a series of accumulators 5, each operable selectively to store and release energy through controlled receipt and release of pressurised hydraulic fluid, as described in more detail below. The system further includes a positive displacement hydraulic pump/motor assembly 8 in fluid communication with the accumulators, a low-pressure hydraulic reservoir 9 in fluid communication with the pump/motor assembly, and a controller 10 to regulate the operation of the system in response to predetermined variable parameters. These primary system components, and the interaction between them, are described in more detail below.

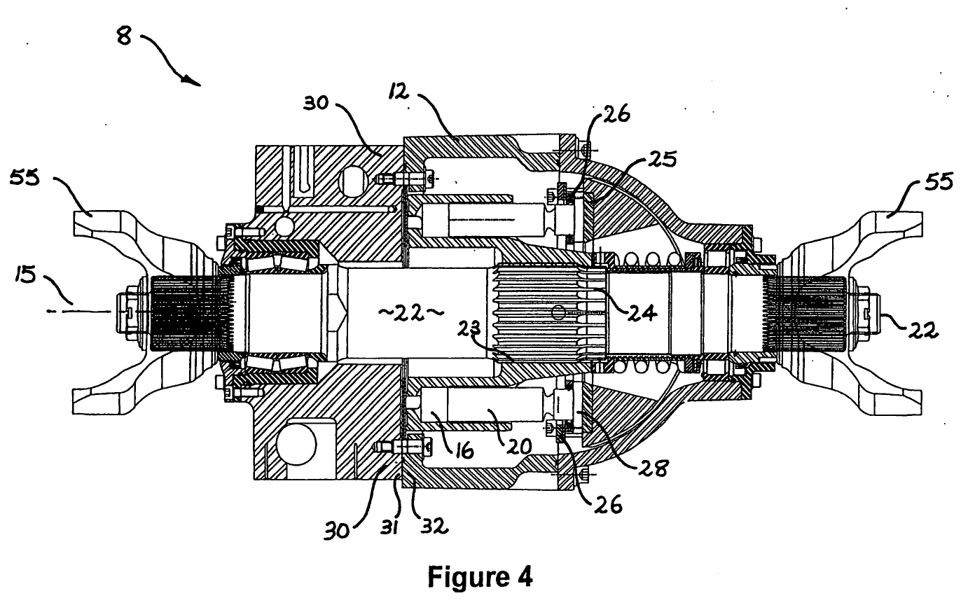

Referring to FIG. 4, the pump/motor unit 8 includes a stationary housing 12 and a cylinder block 13 supported within the housing for rotation about a central axis 15. The block 13 incorporates a circular array of hydraulic cylinders 16 uniformly disposed in parallel relationship about the central rotational axis 15. A corresponding array of axial pistons 20 is reciprocably disposed within the respective cylinders.

A central drive shaft 22 extends through a complementary bore 23 formed in the cylinder block. The shaft is drivingly connected to the cylinder block 13 by coupling means including spline formations 24 to effect rotation of the block about the central axis, as described in more detail below.

A stationary drive plate in the form of swash plate 25 is disposed at one end of the cylinder block (the right-hand end when viewing the drawing). The swash plate is pivotably supported on a cradle within the housing, for adjustable movement within a predetermined range, about an axis substantially normal to the rotational axis of the cylinder block.

A hold-down plate 26 is disposed to locate the free ends of the pistons remote from the valve plate in the appropriate relative spatial relationship, while the end faces of the pistons are formed with followers 28 adapted to engage and slidably traverse the operative surface of the swash plate. In this way, rotation of the cylinder block effects sequentially staggered reciprocation of the pistons, with the amplitude of piston travel being determined by the selected angle of inclination of the swash plate.

A stationary valve plate 30 is disposed at the opposite end of the cylinder block (the left-hand end when viewing the drawings) and is rigidly connected to the housing. The valve plate includes a valve face 31 adapted for sliding rotational engagement with a complementary mating valve face 32 formed on the abutting end of the cylinder block. The valve plate includes inlet and outlet ports adapted alternately for fluid communication with the low-pressure reservoir and the accumulators.

The valving is arranged such that hydraulic fluid is progressively drawn into the cylinders in sequence through the inlet ports as the pistons withdraw away from the valve plate and is subsequently expelled from the cylinders through the outlet ports as the respective pistons are progressively advanced toward the valve plate, under the influence of the swash plate.

The swash plate is pivotably supported within the housing such that the effective angle of inclination with respect to the rotational axis of the cylinder block is adjustable to provide selectively variable flow characteristics. In particular, the swash plate may be progressively and alternately inclined in both a positive and a negative sense, for example by means of hydraulic control cylinders (not shown). This enables the assembly alternately to operate as a motor or a pump, of variable but positive displacement. In this regard, it should be appreciated that the particular valve ports which function as inlets to the cylinders of the pump/motor unit, and those which function as outlets, will alternate according to the operational mode of the unit. Importantly, the swash plate can also be orientated in an intermediate or neutral position in a plane effectively normal to the central axis, such that rotation of the cylinder block produces no reciprocation of the pistons. In this mode, the pump/motor unit induces no net fluid flow into or out of the cylinders, and consequently transfers no significant hydraulic load to the shaft.

The essential elements of construction, and the basic principles of operation, are common to most positive displacement axial piston hydraulic pumps, and being well understood by those skilled in the art, need not be described in more detail.

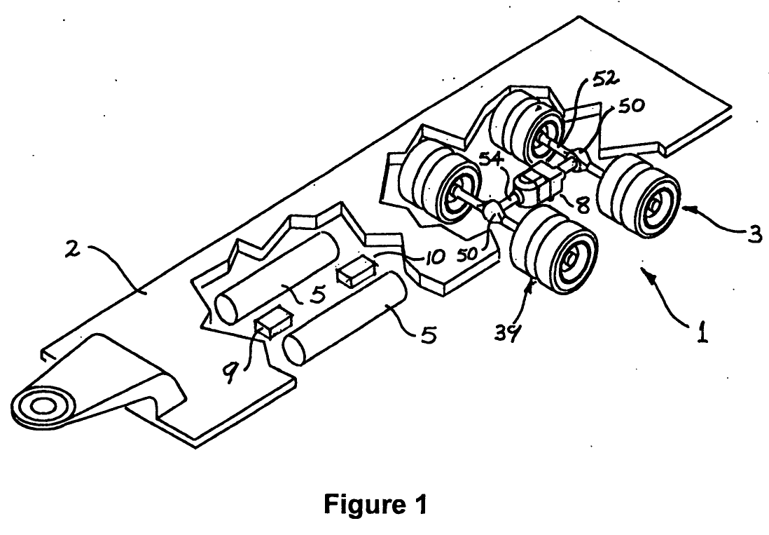

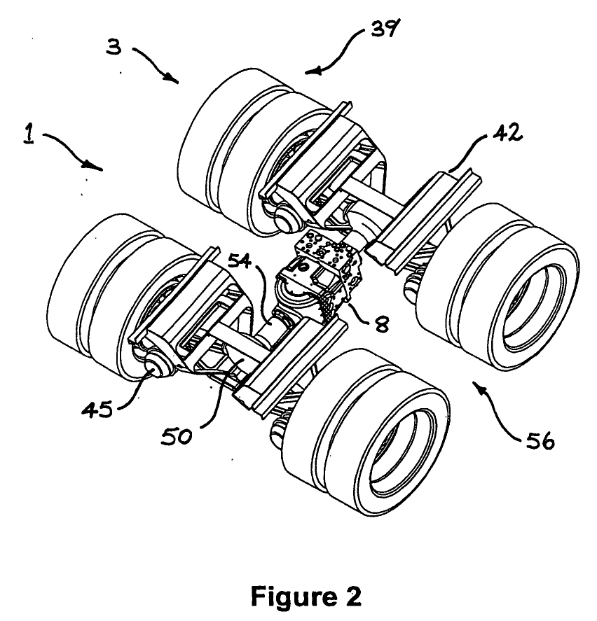

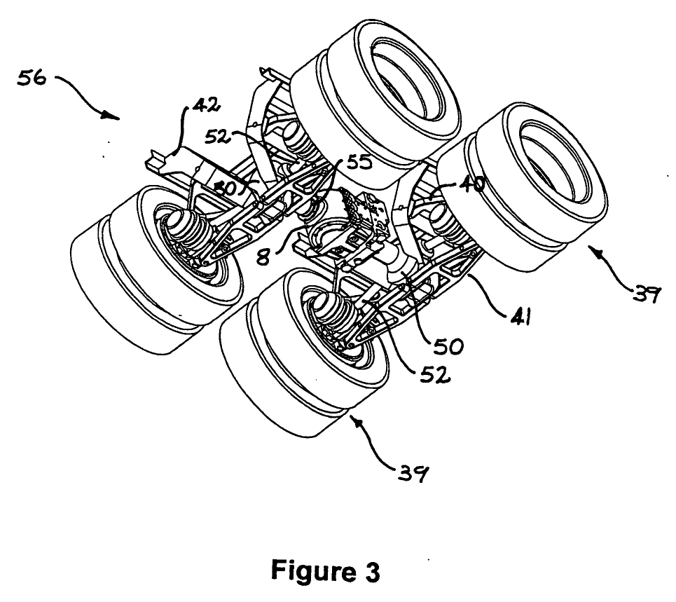

Referring now to FIGS. 1 to 3, the hydraulic pump/motor assembly 8, as described above, forms part of the regenerative energy management system 1, wherein the drive shaft 22 of the pump/motor unit is connected to the wheels of the trailer, which in a conventional application would be “freewheeling”, that is to say isolated from the drive train of the prime mover. In the configuration illustrated, the trailer 2 incorporates two pairs of wheel sets 39. Each wheel set is supported by an upper wishbone 40 and a lower wishbone 41. Each wishbone in turn is pivotably connected to a sub-frame assembly 42. Each wheel set incorporates a power-assisted braking mechanism 45.

The wheel sets of each pair, disposed on opposite sides of the trailer, are connected by a respective differential 50. Each differential incorporates a pair of output shafts 52, which extend outwardly from the respective side gears (not shown) of the associated differential, to form axles for the respective wheel sets. Each differential also incorporates an input or pinion shaft 54. The pinion shafts of the differentials extend coaxially toward one another, and are connected to the opposite ends of the drive shaft 22 of the pump/motor unit, by means of respective universal joints 55. This arrangement permits easy removal of the pump/motor unit from the sub-frame. Alternatively, however, it will be appreciated that a unitary through-shaft may be used.

In either case, in the operative configuration, the two differentials in effect share a common input or pinion shaft, which extends coaxially through the pump/motor unit, to act as the primary drive shaft 22 for that unit, and thereby obviates the need for intermediate gearboxes, chain drives, belt drives, or other transmission mechanisms. This shaft will hereinafter be referred to as the drive shaft for the pump/motor unit and the RDS. It should be understood, however, that this shaft is not driven from an external power source, and is entirely independent of the primary drive line or power train of the prime mover.

In this configuration, the two pairs of wheel sets 39, the associated differentials 50, the interconnecting pinion shafts 54, the pump/motor unit 8, together with the associated chassis or sub-frame 42, braking and suspension elements form a discrete bogie assembly 56 for the trailer. If required, a plurality of positive displacement axial piston pumps can be arranged axially along the drive shaft and may be connected hydraulically to operate in series, parallel, or a combination of both.

A single trailer may incorporate a plurality of such bogie assemblies, the respective drive shafts of which may optionally be interconnected. It will also be appreciated that multiple trailers or wagons, incorporating single or multiple bogie assemblies, may be drawn by a single prime mover. Advantageously, these bogie assemblies can be readily adapted for retrofitting to existing trailer or wagon chassis. Alternatively, however, the principal chassis components of the bogie assembly may be formed integrally with the trailer.

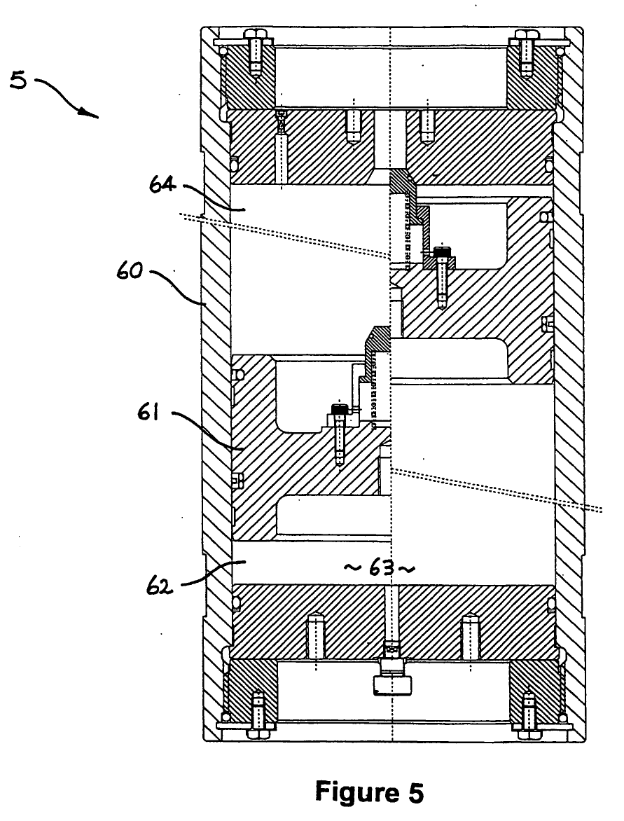

As best seen in FIG. 5, the system further includes energy accumulation means in the form of a pair of hydraulically operable gas/liquid accumulators 5, each comprising a double-ended cylinder 60 and a piston 61 adapted sealingly to float 30 within the cylinder. One side 62 of each cylinder contains a compressible inert gas 63 such as nitrogen, while the other side 64 of the cylinder is in fluid communication with the pump/motor unit via hydraulic lines. Each accumulator is thereby adapted to store energy by receiving pressurised hydraulic fluid into one end 64 of the cylinder so as to compress the gas 63 on the other side, and adapted subsequently to release that energy by expulsion of the hydraulic fluid as the compressed gas is allowed to expand.

This method of energy accumulation and regeneration is well understood by those skilled in the art, and is described in more detail in PCT/AU99/00740. Again, however, it should be emphasised that alternative forms of energy accumulator such as bladder, bellows or diaphragm type accumulators can readily be substituted and further, that any suitable number and combination of accumulators may be used.

In use, the system is selectively operable in any one of three primary modes. In a first braking mode, the system operates to retard the drive shaft of the bogie assembly by pumping hydraulic fluid into the accumulators and thereby compressing the contained gas medium. Alternately, the system is operable in a driving mode to supply supplementary power to the drive shaft of the bogie assembly using the pressurised hydraulic fluid from the accumulators. In the braking mode, it will be appreciated that the hydraulic pump/motor unit operates as a pump powered by the drive shaft, whereas in the driving mode, the unit operates as a motor powered by pressurised hydraulic fluid from the accumulators. The system is also operable in a third neutral or “free wheeling” mode, whereby the drive shaft is substantially unaffected by the pump/motor unit, aside from any residual frictional drag.

The three primary operational modes are regulated according to the angle of inclination of the swash plate 25. This angle is regulated by an hydraulic or pneumatic actuator in response to control signals from the electronic RDS management system 10. The RDS management system is programmably responsive to a predetermined series of system parameters such as accelerator, brake and clutch pedal positions, engine speed, gear selection, engine inlet manifold pressure, turbo boost pressure, swash plate position, drive line torque, accumulator pressure and hydraulic pump/motor pressure. The system may also be pre-programmed with topographical mapping and terrain data. This formal programming enables the system effectively to anticipate inclines and declines as well as stopping and acceleration points on known routes, and to optimise the performance of the RDS on that basis. The general operating principles in this respect are described in more detail in PCT/AU99/00740.

In the present application, the control system is ideally arranged to provide proportional retardation under the same controlling parameters as the conventional braking system. In other words, the trailer RDS system is linked to the main vehicle braking system, and programmed such that the braking mode of the RDS unit is progressively activated as the conventional brakes are progressively applied. Sensors to facilitate operation of the system in this mode can include position transducers or limit switches associated with the foot or hand brake, accelerometers, pressure transducers in the hydraulic braking circuit, or other suitable mains. Ideally, the system is programmed such that the supplementary retarding force is variable, and dependent upon the primary braking pressure applied by the driver. Importantly, the system can be configured such that in the case of a trailer being drawn behind a prime mover, the braking force applied to the trailer is always greater than that applied to the prime mover, thereby substantially reducing the possibility of the vehicle jack-knifing. The control system of the unit can also conveniently be linked to the accelerator of the vehicle, and configured automatically to provide proportional supplementary propulsion through the wheels of the trailer, when the vehicle is under acceleration. Advantageously, these modes of operation reduce the extent of manual intervention required of the driver, so as not to divert the driver's attention and so as to minimise the potential for operator error. It will be appreciated, however, that in less sophisticated implementations, the RDS modes may simply be switched on or off as required according to predetermined system parameters.

In a preferred implementation, the system additionally includes a command panel, operable by the driver of the vehicle to select various alternative operational modes and characteristics of the system. The command panel preferably includes a speed selector, for selecting the speed at which retardation of the trailer occurs, and also to govern the speed of the trailer under propulsion. For example, if the speed for initiation of retardation mode were set to commence at 100 km/h, then the system would automatically apply a progressive retardation force whenever the vehicle and trailer exceeded that speed, irrespective of whether the conventional braking system of the vehicle were activated. In this mode, retardation is commenced by ramping the swash plate angle of the pump/motor unit by an initial increment. If speed continues to increase, as may occur for example if the vehicle is travelling down a steep incline, the swash plate angle is progressively increased until the vehicle is slowed to the selected speed. At that point, the controller will reduce the ramp angle of the swash plate until the pump/motor unit reverts to the neutral mode. The system is also programmed so that the retardation mode will be deactivated if the driver commences acceleration. This may be detected by various means such as an accelerator position transducer, or a pressure transducer in the turbo boost manifold.

This mode is useful in helping the driver to avoid inadvertently exceeding speed limits, while at the same time reducing the level of driver input required to maintain a constant speed over undulating terrain. In practice, the setting may be specified marginally above the speed limit, to allow for calibration error in the speed monitoring system.

Gear change modes may also be programmed, for example to initiate propulsion of the trailer and minimise loss of momentum during up-changes, which can be particularly important in hilly terrain. Similarly, the system can be programmed to initiate retardation during down-changes, to minimise brake and clutch wear.

Additionally, the system ideally includes an alarm, or a series of alarms, to alert the driver when various specified parameters are exceeded. Such alarms may be programmed to sound, for example, if the accumulator is fully charged, fully discharged, or when selected speeds are exceeded. Such alarms may be visual, aural, tactile, or a combination, and can ideally be selectively deactivated by the driver when desired.

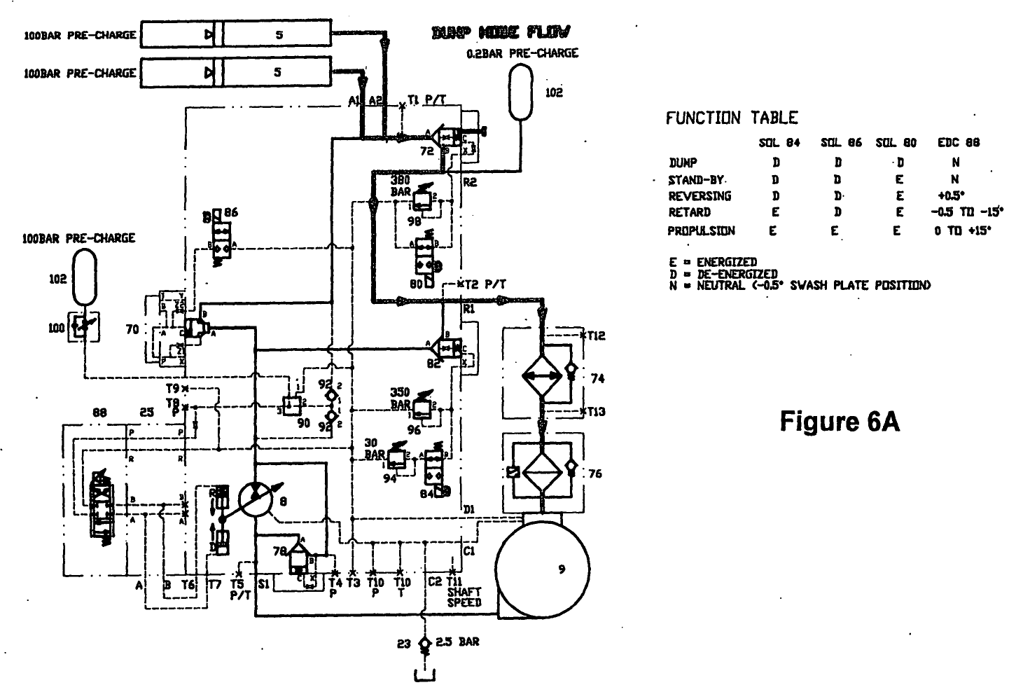

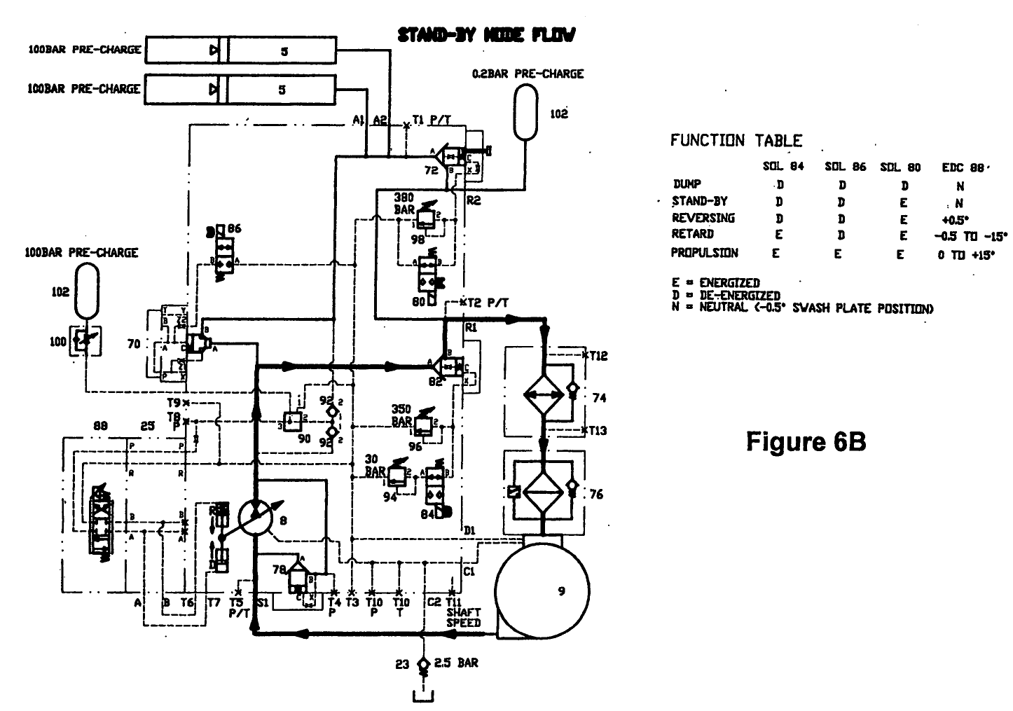

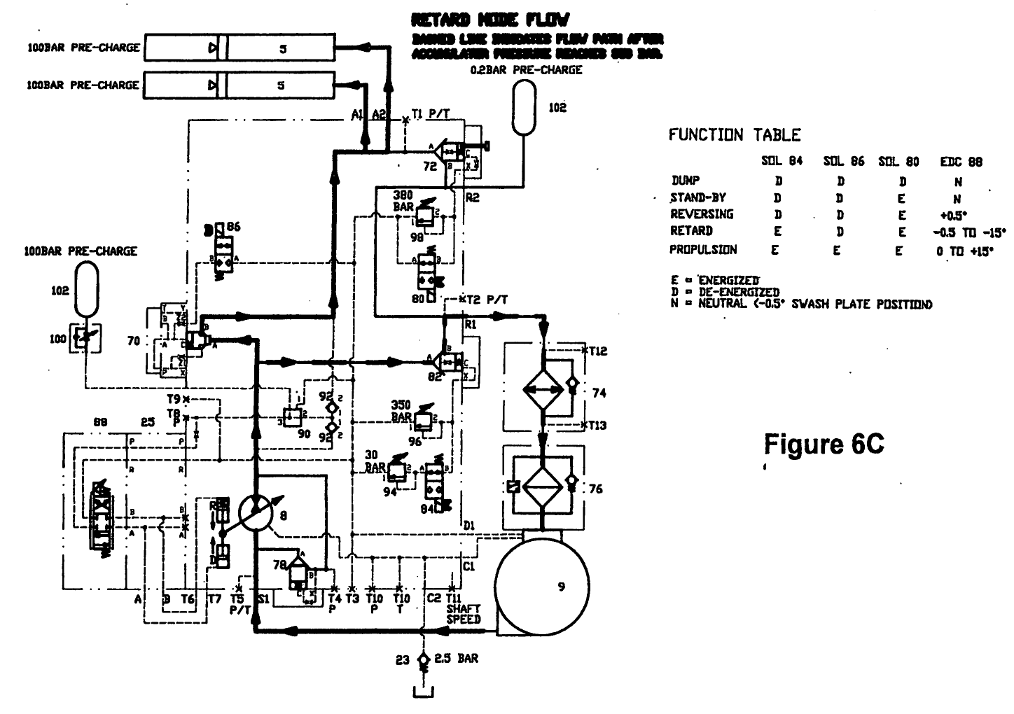

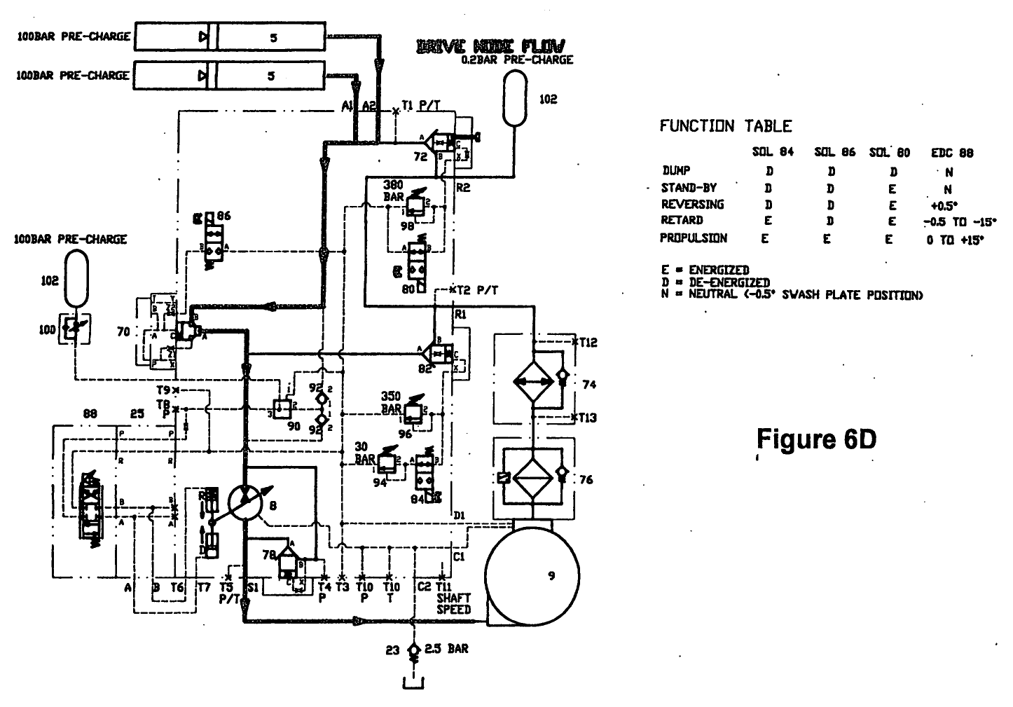

FIGS. 6A to 6D are a sequence of hydraulic schematics showing in detail one preferred configuration of hydraulic control circuitry for the system, operating in the different modes or states as outlined broadly above. In these schematics, the primary flow path of the hydraulic circuit in each state is highlighted, for ease of explanation.

The principal components of the circuit are as follows:
Piston Type Hydraulic Accumulators 5;
Pump/Motor Drive Unit 8;
Low-pressure Reservoir 9;
Bi-Directional Drive Logic Cartridge 70;
Dump/Thermal Relief Flow Control Logic Cartridge 72;
Oil-Air Cooler with Bypass 74;
Filter Assembly 76;
Anti-Cavitation Check Valve Cartridge 78;
Dump/Thermal Relief Solenoid 80;
Stand-by Relief Valve Logic Cartridge 82;
Stand-by Two-Way Solenoid Valve Cartridge 84;
Two-way Drive Solenoid Valve Cartridge 86;
Proportional Directional Control Valve 88;
Dummy Cartridge Valve 90;
Check Valve Cartridge 92;
Direct Acting Relief Cartridge (30 Bar Setting) 94;
Direct Acting Relief Cartridge (350 Bar Setting) 96;
Direct Acting Relief Cartridge (380 Bar Setting) 98;
Flow Controller 100;
Bladder Accumulator with Pre-Charge 102;
Check Valve with 2.5 Bar Cracking 104.
Ancillary components represented graphically using conventional symbols.

The circuit is selectively operable in the primary modes or states, as outlined below.

1. Natural State

With all control signals removed (i.e. all solenoids de-energized), the system is effectively disabled in a natural rest state, as represented in FIG. 6A. In this state, the system is not capable of holding accumulated pressure. However, the pump's natural position is biased to the retard side. This means that any forward pump rotation in this state will result in a small flow of oil from the reservoir, through the pump, and returning to the reservoir via the essentially unrestricted flow path (shown in bold in FIG. 6A) through the Drive Logic Cartridge 70 and Dump/Thermal relief Logic Cartridge 72, then via the cooler 74 and filter 76 without providing any significant retard torque or drag. Any reverse pump rotation in this state will result in the same small flow of oil around the Anti-Cavitation Check valve Cartridge 78. However reverse pump direction in this natural state for prolonged periods is ideally to be avoided (see Reverse State below).

2. Dump State

This state, as also illustrated in FIG. 6A, is identical to the natural state described above. However, if this state is entered from any of the dynamic states described below, it will result in the same disabled condition as outlined above, with the additional effect of dumping any oil stored in the accumulators at a controlled rate via the Dump/Thermal relief Logic Cartridge 72. The flow rate through this cartridge is adjustable and is set during commissioning.

3. Stand-By State

To achieve this state, which is illustrated in FIG. 6B, power is applied to the Dump/Thermal relief Solenoid 80. This changes the pilot condition of the Dump/Thermal relief Logic cartridge 72, which will now act as a 380 Bar relief valve, enabling the system to store oil in the accumulators. However, there is still minimal retard torque or drag in this state, as the pump is still only operating on a shallow swash plate angle and the oil flow is still circulating back to the reservoir via the Stand-By Logic Cartridge 82, the pilot condition of which causes it to act as a 30 Bar relief valve. The purpose of this is to provide some backpressure to the pump, as the system will operate in this state for relatively long periods of time.

4. Additional Cooling

Additional cooling capacity can be achieved between retard and drive cycles if required. With the system in the Stand-by state (see FIG. 6B), increasing the swash plate angle will increase the flow of oil circulating around the system and returning to the reservoir via the cooler, without creating substantial additional drag.

5. Reversing State

When the rotational direction of the drive line is reversed, the system is ideally switched to the reversing state. This is exactly the same as Stand-by state. However, in order to achieve flow in the desired direction, the pump swash plate is moved to a shallow propulsion angle.

6. Retardation State

As best illustrated in FIG. 6C, when it becomes desirable to collect energy from the drive system, energization of the Stand-by Solenoid 84 will alter the pilot condition of the Stand-by Logic Cartridge 82 and cause it to act as a 350 Bar relief valve. The Dump/Thermal relief Solenoid 80 will also be energized to enable it to hold oil in the accumulators. In this state, any oil being pumped from the reservoir will flow via the Drive Logic Cartridge 70, which will act as a check valve and allow oil flowing in this direction to pass through to the accumulators. In this state, the retard torque available can be adjusted by varying the swash plate angle. Once the accumulators are full to a pressure of 350 Bar, the oil being pumped will flow through the Stand-by Logic Cartridge 82 at 350 Bar, and back to the reservoir via the cooler and filter. This flow path, which becomes operative only after the accumulators reach the threshold pressure of 350 Bar, is represented by the thickened dashed line in FIG. 6C. The swash plate angle required at any given time to provide a specified retard torque is a function, among other things, of the pump speed, accumulator pressure and hydro-mechanical efficiency. In the embodiment illustrated, the swash plate angle is limited so as not to exceed a system flow of 370 litres per minute. If a situation occurs where it is necessary to cancel the retarding effect quickly, then de-energizing the Stand-by Solenoid 84 will allow oil to flow through the Stand-by Logic Cartridge 82 at 30 Bar, thereby removing the load from the pump, and removing the retarding effect. At the same time, the pump swash plate angle should be commanded to the shallow Stand-by position.

7. Drive State

As best seen in FIG. 6D, when it becomes desirable to discharge energy back into the drive system, energization of all solenoids will create a state where the oil from the accumulators will be allowed to flow back to the pump. In particular, energization of the Drive Solenoid 86 will vent the pilot on the Drive Logic Cartridge 70, allowing the accumulators to open, and then hold the Logic Cartridge open as the oil from the accumulators flows through. With the swash plate in the propulsion or reverse direction, the pump will now act as a motor, supplying drive energy as the oil flows through it and back to the reservoir. The drive torque available can now be adjusted by varying the swash plate angle. The swash plate angle required at any given time to deliver a specified drive torque is again primarily a function of the speed, accumulator pressure and hydro-mechanical efficiency. During the drive cycle, the electronic control system is configured to monitor the accumulator or reservoir capacity, so that the swash plate can be moved back to neutral and the system returned to the Stand-by state, before the accumulators are completely discharged. If this fails to happen, the oil will begin to be pumped around the Anti-Cavitation Check Cartridge 78.

8. Emergency Drive

If the existing drive system should become disabled, the regenerative energy management system can be utilized to provide emergency drive, provided there is oil in the accumulators. Forward drive can be achieved in the same way as described in relation to the above Drive state. Reverse emergency drive can also be achieved by switching to the Drive state, but commanding the swash plate to the Retard direction.

The system as described enables a substantial proportion of the braking energy of the trailer to be captured, stored and reused when required. Because of the significant weight of trailers and wagons in freight haulage applications, the quantity of this energy is significant. The fact that it can be harnessed, while providing supplementary braking, in retardation mode, and later diverted back into the drive line when required during acceleration, means that the system can dramatically reduce wear in vital components such as brakes, clutches and transmissions. At the same time, dramatic reductions in fuel consumption can be achieved. The system also confers substantial safety benefits by providing a supplementary braking mechanism, operating entirely independently of the primary hydraulic braking system. The fact that the system operates independently of the vehicle drive line also represents a significant advantage in terms of safety, because the system can be designed to operate effectively, even in the event of a complete failure in both the primary braking system, and the primary drive line or power train, of the vehicle. Aside from the obvious benefits in terms of reduced fuel cost and component wear, these unique features have the potential to reduce a number of common accidents, including those arising from brake failure and jack-knifing. In all these respects, the invention represents both a practical and a commercially significant improvement over the prior art.

Although the invention has been described with reference to specific examples, it will be appreciated by those skilled in the art that the invention may be embodied in many other forms. In particular, while the invention is described predominantly in the context of heavy road going vehicles, it will also be appreciated that regenerative drive systems of this type can be readily adapted to practically any environment in which a wheeled trailer, wagon, cart, carriage, container, bogie or other non-powered transportation vehicle is drawn behind, pushed ahead of, or otherwise connected to, a prime mover or other source of motive power, whether in a road, off-road, rail, sea or air transportation context, and whether in domestic, commercial, civil or military applications.

1. A regenerative energy management system adapted for use with a compound vehicle comprising a prime mover including an engine connected to driven wheels via a drive train and a trailer including at least one independent wheel isolated from the drive train, the energy management system including:
energy accumulation means operable selectively to store and release energy through controlled receipt and release of pressurised hydraulic fluid;
a positive displacement hydraulic pump/motor assembly in fluid communication with the energy accumulation means; and
a low-pressure hydraulic reservoir in fluid communication with the pump/motor assembly;
the pump/motor assembly having a drive shaft adapted for connection to at least an associated one of the independent wheels of the trailer;
the system being arranged such that in a braking mode the pump/motor assembly retards the associated wheel of the trailer by pumping hydraulic fluid into the accumulation means, in a driving mode the pump/motor assembly supplies supplementary power to the associated wheel of the trailer using pressurised hydraulic fluid from the accumulation means, and in a neutral mode the pump/motor assembly exerts no substantial driving or retarding influence on the associated trailer wheel;
the system thereby in use being adapted to supply regenerative drive and retardation to the trailer substantially independently of the prime mover.

2. A regenerative energy management system according to claim 1, wherein the hydraulic pump/motor assembly includes:
a rotary cylinder block having a central axis and incorporating a generally circular array of cylinders disposed around the axis;
a corresponding plurality of pistons reciprocably disposed within the respective cylinders;
a drive plate disposed at one end of the cylinder block to effect sequentially staggered reciprocation of the pistons in response to rotation of the cylinder block;
a stationary valve plate disposed at an opposite end of the cylinder block, the valve plate having a valve face adapted for sliding rotational engagement with a complementary mating face formed on the cylinder block;
the valve plate further including at least one inlet port adapted for fluid communication with the low-pressure reservoir and at least one outlet port adapted for fluid communication with the accumulation means;
the ports being disposed such that in use, hydraulic fluid is progressively drawn into the cylinders in sequence through the inlet ports as the respective pistons are displaced away from the valve plate and subsequently expelled from the cylinders through the outlet ports as the pistons are progressively displaced toward the valve plate.

3. A regenerative energy management system according to claim 2, wherein the cylinders are disposed in generally parallel relationship around the axis.

4. A regenerative energy management system according to claim 2, wherein the cylinders are disposed in generally radial relationship around the axis.

5. A regenerative energy management system according to any one of claims 2 to 4, wherein the drive shaft extends coaxially through a complementary bore formed in the cylinder block, to effect rotation of the cylinder block about the central axis.

6. A regenerative energy management system according to claim 5, wherein the pump/motor assembly further includes a selectively releasable decoupling mechanism disposed effectively intermediate the drive shaft and the cylinder block.

7. A regenerative energy management system according to claim 6, wherein the decoupling mechanism is adapted in an engaged mode to connect the drive shaft to the cylinder block and in a disengaged mode to allow the drive shaft to rotate substantially independently of the cylinder block.

8. A regenerative energy management system according to claim 7, wherein the decoupling means include a clutch mechanism disposed coaxially around the drive shaft, to selectively transmit rotary drive between the drive shaft and the cylinder block.

9. A regenerative energy management system according to claim 2, wherein the drive plate takes the form of a stationary swash plate, which is inclined with respect to the central rotational axis of the cylinder block.

10. A regenerative energy management system according to claim 9, wherein floating ends of the pistons remote from the valve plate include followers adapted to slide over the swash plate as the cylinder block rotates.

11. A regenerative energy management system according to claim 10, wherein a hold-down plate is disposed to capture the floating ends of the pistons and retain the followers in sliding contact with the swash plate.

12. A regenerative energy management system according to any one of claims 9 to 11, wherein an angle of inclination of the swash plate is selectively adjustable, to provide variable flow rate characteristics.

13. A regenerative energy management system according to claim 12, wherein the swash plate is adapted to be selectively inclined in a positive or a negative sense, thereby enabling the assembly alternately to operate as a motor or a pump.

14. A regenerative energy management system according to claim 13, wherein the swash plate can also be oriented in an intermediate or neutral position, effectively normal to the central axis, such that rotation of the cylinder block causes no movement of the pistons, hence induces no net flow into or out of the cylinders through the ports, and therefore causes no substantial load on the system.

15. A regenerative energy management system according to claim 2, wherein the pump/motor assembly includes at least three external ports to permit ingress and egress of hydraulic fluid, with a first port communicating with an inlet of the hydraulic reservoir, a second port communicating with an outlet of the hydraulic reservoir, and a third port communicating with the accumulation means.

16. A regenerative energy management system according to claim 15, wherein a heat exchanger is disposed between the first port and the reservoir.

17. A regenerative energy management system according to any one of the preceding claims, wherein a plurality of the pumps is arranged axially along the drive shaft.

18. A regenerative energy management system according to any one of the preceding claims, further including a flow control circuit through which hydraulic fluid may be selectively directed, the control circuit being adapted to provide a controllable resistance enabling the pump/motor unit selectively to exert a retarding force on the drive shaft when the accumulators are fully charged.

19. A regenerative energy management system according to any one of the preceding claims, wherein the accumulation means include a gas/liquid accumulator comprising a double-ended accumulation cylinder and a piston adapted to float sealingly within the cylinder.

20. A regenerative energy management system according to claim 19, wherein one side of the accumulation cylinder contains a compressible inert gas, and the other side of the cylinder is connected hydraulically to the pump/motor unit.

21. A regenerative energy management system according to claim 20, wherein the accumulator is adapted to store energy by pumping hydraulic fluid into one side of the cylinder, so as to compress the gas on the other side by displacement of the floating piston, and subsequently to release that energy by expulsion of hydraulic fluid as the compressed gas expands.

22. A regenerative energy management system according to claim 21, wherein the output shaft of the primary motor and the drive shaft of the pump/motor unit are integrally formed.

23. A regenerative energy management system according to any one of the preceding claims, wherein the pump/motor unit is mounted directly to a freewheeling axle supporting one or more of the associated non-driven wheels of the wagon, such that the axle and the drive shaft of the pump/motor unit are coupled for conjoined rotation.

24. A regenerative energy management system according to claim 23, wherein the axle and the output shaft are integrally formed.

25. A regenerative energy management system according to any one of the preceding claims, wherein the pump/motor unit is connected to a corresponding pair of the associated non-driven wheels disposed on opposite sides of the trailer via a differential.

26. A regenerative energy management system according to claim 25, wherein a main pinion shaft for the differential forms the drive shaft of the pump/motor unit.

27. A regenerative energy management system according to claim 26, wherein two or more pairs of wheels are connected to the same pump/motor unit via respective differentials and a common pinion shaft, whereby four or more of the associated wheels of the trailer are regulated by a single pump/motor unit.

28. A regenerative energy management system according to claim 27, wherein the pairs of wheels, the differentials, the common pinion shaft and the pump/motor unit are incorporated into a discretely detachable bogie assembly.

29. A regenerative energy management system according to claim 28, wherein the differentials have limited slip or locking capability, thereby permitting torque bias in the event of one wheel losing traction.

30. A regenerative energy management system according to any one of claims 27 to 29, wherein additional pump/motor units are disposed along the common pinion shaft.

31. A regenerative energy management system according to any one of the preceding claims, further including a control system configured to regulate braking and driving torques applied to the associated wheel in the respective braking and driving modes, in response to braking and driving control inputs to the prime mover.

32. A regenerative energy management system according to any one of the preceding claims, being arranged to provide effective braking functionality for the compound vehicle in the braking mode, substantially independently of a conventional friction braking system.

33. A regenerative energy management system according to any one of the preceding claims, being arranged to provide at least a limited degree of driving functionality for the compound vehicle in the driving mode, substantially independently of the drive train of the prime mover.

34. A regenerative energy management system according to claim 32 or claim 33, wherein selected wheels constituting a major proportion of wheels in the trailer are coupled to the regenerative energy management system.

35. A regenerative energy management system according to any one of the preceding claims, being supplemented by a further regenerative energy management system connected directly to the drive line of the prime mover.
